(19) United States
(12) Patent Application Publication
(10) Pub. No.: US 2026/0050163 A1
(43) Pub. Date: Feb. 19, 2026

(54) Devices with Adjustable Displays

(71) Applicant: Apple Inc., Cupertino, CA (US)

(72) Inventor: Paul X Wang, Cupertino, CA (US)

(21) Appl. No.: 18/802,874

(22) Filed: Aug. 13, 2024

(51) Int. Cl. G02B 27/01; G02B 27/18

(52) U.S. Cl. CPC G02B 27/0172; G02B 27/0176; G02B 27/18; G02B 2027/0132; G02B 2027/0156; G02B 2027/0159

(57) ABSTRACT

A head-mounted device may include one or more displays, which may be movable between a first state in which the displays are in a horizontal field-of-view mode and a second state in which the displays are in a vertical field-of-view mode. The displays may be rotatable or expandable between the first state and the second state. An encoder and/or detents determine positions of the displays, and content on the displays may be modified based on the determined positions. The displays may be moved by one or more motors and/or by a user of the device. The displays may be rotatable in a single plane or may be rotatable in multiple planes. An entirety of the displays or portions of the displays, such as projectors and/or waveguides, may be moved to move the displays between the first and second states.

### BACKGROUND

This disclosure relates to electronic devices, including electronic devices with displays.

Electronic devices can include displays that provide images near the eyes of a user. Such electronic devices may include virtual or augmented reality headsets with displays having optical elements that allow users to view the displays.

### SUMMARY

A head-mounted device such as a pair of glasses, goggles, or other eyewear may include one or more displays in a head-mounted housing. The displays may be movable between a first state in which the displays are in a horizontal field-of-view mode and a second state in which the displays are in a vertical field-of-view mode.

The displays may be rotatable or expandable between the first state and the second state. The displays may be moved by one or more motors and/or by a user of the device. The head-mounted housing may also be movable to accommodate the movement of the displays.

An encoder and/or detents determine positions of the displays, and content on the displays may be modified based on the determined positions. For example, landscape content may be displayed when the displays are in the horizontal field-of-view mode, and portrait content may be displayed when the displays are in the vertical field-of-view mode.

The displays may be rotatable in a single plane or may be rotatable in multiple planes. For example, the displays may be mounted to the head-mounted device housing using a mount, such as a ball-and-socket joint, that allows the displays to rotate in multiple planes.

An entirety of the displays or portions of the displays, such as projectors and/or waveguides, may be moved to move the displays between the first and second states. The displays may have one or more modified components to accommodate the movement between the first and second states. For example, the displays may be coupled to circuitry using a flexible service loop, the displays may have sidewalls with multiple curvatures, optical modules of the displays may be coupled using an adjustable connector, and/or lenses of the displays may have modified modulation transfer function (MTF) centers.

### BRIEF DESCRIPTION OF THE DRAWINGS

FIG. 1 is a diagram of an illustrative electronic device such as a head-mounted device having a display in accordance with some embodiments.

FIG. 2 is a top view of an illustrative electronic device such as a head-mounted device having displays and an optical system for providing real-world light and light from the displays to eye boxes in accordance with some embodiments.

FIG. 3 is a front view of an illustrative electronic device such as a head-mounted device that includes rotatable displays in accordance with some embodiments.

FIG. 4 is a perspective view of an illustrative display that is rotatable in multiple planes and that has sidewalls with multiple curvatures in accordance with some embodiments.

FIG. 5 is a front view of an illustrative flex service loop that may couple a rotatable display to associated circuitry in accordance with some embodiments.

FIG. 6 is a front view of an illustrative electronic device such as a head-mounted device that includes a display with an expandable optical module in accordance with some embodiments.

FIG. 7 is a front view of an illustrative head-mounted device housing, such as a frame, that is expandable to accommodate an expandable optical module in accordance with some embodiments.

FIG. 8 is a front view of an illustrative electronic device such as a head-mounted device that includes a display that magnetically attaches to a frame in multiple positions in accordance with some embodiments.

FIG. 9 is a front view of an illustrative electronic device such as a head-mounted device that includes a display with a waveguide and a projector that moves relative to the waveguide in accordance with some embodiments.

FIG. 10 is a top view of an illustrative electronic device such as a head-mounted device that includes optical modules coupled with an adjustable connector to change a center-to-center spacing between the optical modules in accordance with some embodiments.

FIG. 11 is a front view of an illustrative optical module that includes a lens with one or more modulation transfer function (MTF) centers in accordance with some embodiments.

FIG. 12 is a top view of an illustrative electronic device such as a head-mounted device having housing portions that form a channel in which an optical module is coupled and can rotate in accordance with some embodiments.

FIG. 13 is a front view of an illustrative electronic device such as a head-mounted device that includes an encoder and/or detents between a housing and a rotatable display in accordance with some embodiments.

### DETAILED DESCRIPTION

An electronic device, such as a head-mounted device, may include head-mounted support structures, such as a housing or a frame. Displays may be mounted in the housing or frame to display images to eye boxes of a user of the device. Optical systems/modules may be incorporated between the displays and the eye boxes. The optical modules may focus the images and/or combine the images with the exterior (real-world) of the device.

The displays and/or the optical modules may be movable within the housing or frame. In particular, it may be desirable to switch the displays from a horizontal field-of-view (FOV) mode to a vertical FOV mode. To switch the displays between the horizontal FOV mode to the vertical FOV mode, the displays and/or the optical systems may be rotated, unfolded, and/or extended to provide additional display area in the horizontal or vertical direction. In this way, a head-mounted device may be adjustable into a vertical FOV mode, which may allow for better production of portrait-oriented content, such as videos or images taken with a vertical FOV and/or scrolling content that is more comfortably displayed with a vertical FOV.

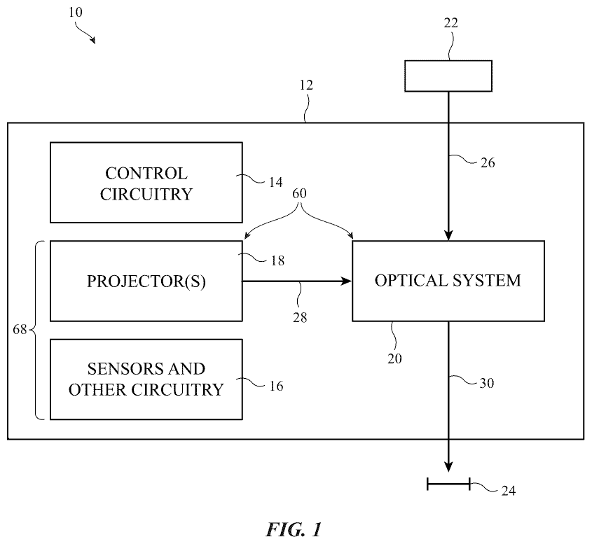

Electronic device 10 of FIG. 1 may be a head-mounted device such as a pair of glasses or other eyewear having one or more displays and optical systems. The displays in device 10 may include near-eye displays 60 mounted within support structure such as housing 12. Housing 12 may have the shape of a pair of eyeglasses or goggles (e.g., supporting frames), may form a housing having a helmet shape, or may have other configurations to help in mounting and securing the components of near-eye displays 60 on the head or near the eye of a user. Near-eye displays 60 may include one or more display projectors such as projectors 18 (sometimes referred to herein as display modules 18) and one or more optical systems such as optical systems 20 (sometimes referred to as optical modules 20 herein). Projectors 18 may be mounted in a support structure such as housing 12 and/or may be mounted on optical system 20. Each projector 18 may emit display light 28 that is redirected towards a user's eye at eye box 24 using an associated one of optical systems 20. Display light 28 may be, for example, visible light (e.g., including wavelengths from 400-700 nm) that contains and/or represents display content such as a scene or object (e.g., as modulated onto the display light using the display data provided by the control circuitry to the display module).

The operation of device 10 (sometimes referred to as glasses 10, eyewear 10, system 10, head-mounted device 10, etc.) may be controlled using control circuitry 14 (also referred to as controller 14 herein). Control circuitry 14 may include storage and processing circuitry for controlling the operation of device 10. Control circuitry 14 may include storage such as hard disk drive storage, nonvolatile memory (e.g., electrically-programmable-read-only memory configured to form a solid-state drive), volatile memory (e.g., static or dynamic random-access-memory), etc. Processing circuitry in control circuitry 14 may include one or more processors (e.g., microprocessors, microcontrollers, digital signal processors, baseband processors, etc.), power management units, audio chips, graphics processing units, application specific integrated circuits, and other integrated circuits. Software code may be stored on storage in control circuitry 14 and run on processing circuitry in control circuitry 14 to implement operations for device 10 (e.g., data gathering operations, operations involving the adjustment of components using control signals, image rendering operations to produce image content to be displayed for a user, etc.).

Device 10 may include input-output circuitry such as input-output devices 68. Input-output devices 68 may be used to allow data to be received by device 10 from external equipment (e.g., a tethered computer, a portable device such as a handheld device or laptop computer, or other electrical equipment) and to allow a user to provide head-mounted device 10 with user input. Input-output devices 68 may also be used to gather information on the environment in which device 10 (e.g., head-mounted device 10) is operating. Output components in devices 68 may allow device 10 to provide a user with output and may be used to communicate with external electrical equipment. Input-output devices 68 may include sensors and other components 16 (e.g., image sensors for gathering images of real-world objects that are digitally merged with virtual objects on display 60 in device 10, accelerometers, depth sensors, light sensors, haptic output devices, speakers, batteries, wireless communications circuits for communicating between device 10 and external electronic equipment, etc.) and projectors 18 of display(s) 60.

Projectors 18 may include liquid crystal displays, organic light-emitting diode displays, laser-based displays, or displays of other types. Projectors 18 may include light sources, emissive display panels, transmissive display panels that are illuminated with illumination light from light sources to produce image light, reflective display panels such as digital micromirror display (DMD) panels and/or liquid crystal on silicon (LCOS) display panels that are illuminated with illumination light from light sources to produce display light 28, etc.

Optical modules 20 may form lenses that allow a viewer (e.g., a viewer's eye at eye box 24) to view images on display(s) 60. There may be two optical modules 20 (e.g., for forming left and right lenses) associated with respective left and right eyes of the user. A single display 60 may produce images for both eyes, or a pair of displays 60 may be used to display images. In configurations with multiple displays (e.g., left and right displays), the focal length and positions of the lenses formed by optical module 20 may be selected so that any gap present between the displays will not be visible to a user (e.g., so that the images of the left and right displays overlap or merge seamlessly).

If desired, optical module 20 may contain components (e.g., an optical combiner formed from reflective components, diffractive components, refractive components, a waveguide, a direct view optical combiner, one or more lenses, and/or other optics) to allow real-world light 26 (sometimes referred to as world light 26, ambient light 26, outside light 26, etc.) from real-world (external) objects such as real-world (external) object 22 to be combined optically with displayed images (e.g., virtual, computer-generated images, camera-captured images, and/or other displayed images) in display light 28. Light 30 that reaches eye box 24 may include only display light 28, may include only outside light 26, or may include both display light 28 and outside light 26, depending on the mode in which display 60 is operating and/or the configuration of display 60. In this type of system, which is sometimes referred to as an augmented reality system, a user of device 10 may view both real-world content (e.g., world light 26 from object 22) and display content from projectors 18 that is overlaid on top of the real-world content. Real-world light 26 may include ambient light as well as display light generated by external displays (e.g., a cellular telephone display, a tablet computer display, or other suitable display that is viewed through glasses 10), whereas display light 28 may originate from projectors 18 within device 10. Display light 28 may include computer-generated display content as well as camera-captured display content. In camera-based augmented reality systems, a camera captures real-world images of object 22 and this content is digitally merged with virtual content at optical system 20.

Device 10 may, if desired, include wireless circuitry and/or other circuitry to support communications with a computer or other external equipment (e.g., a computer that supplies display 60 with display content). During operation, control circuitry 14 may supply image content to display 60. The content may be remotely received (e.g., from a computer or other content source coupled to device 10) and/or may be generated by control circuitry 14 (e.g., text, other computer-generated content, etc.). The content that is supplied to display 60 by control circuitry 14 may be viewed by a viewer at eye box 24.

If desired, device 10 may include an optical sensor. The optical sensor may be used to gather optical sensor data associated with a user's eyes at eye box 24. The optical sensor may, for example, be a gaze tracking sensor that gathers optical sensor data such as gaze image data (gaze tracking image data or gaze tracking sensor data) from a user's eye at eye box 24. Control circuitry 14 may process the optical sensor data to identify and track the direction of the user's gaze in real time. Control circuitry 14 may perform any desired operations based on the tracked direction of the user's gaze over time. This is merely illustrative. If desired, device 10 may not include any gaze tracking sensors.

Optical system 20 may include any desired optics for directing display light 28 and outside light 26 to eye box 24. In some implementations, optical system 20 includes left and right waveguides that provide left and right display light to respective left and right eye boxes. The waveguides propagate the display light via total internal reflection. Each waveguide may include an input coupler that couples display light into the waveguide, an output coupler that couples the display light out of the waveguide, and optionally a cross coupler or pupil expander for redirecting and/or expanding the display light propagating within the waveguide via total internal reflection. The input coupler, output coupler and/or cross coupler may include diffractive structures such as surface relief gratings, volume holograms, metagratings, or other diffractive gratings, reflective structures such as louvered mirrors, and/or any other desired optical coupling structures.

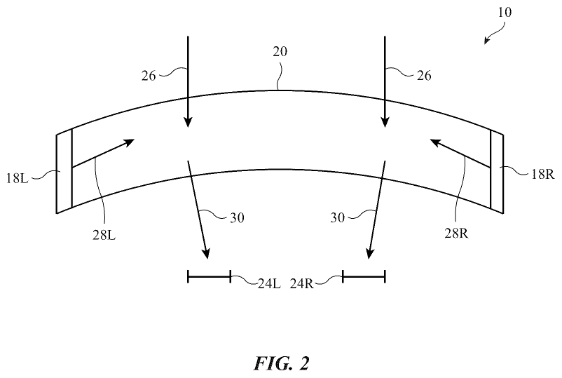

In some implementations, which are described herein as an example, optical system 20 may include optics arranged in a birdbath architecture. FIG. 2 is a top view showing an illustrative example of optical system 20. Device 10 may include a first (left) projector 18L that emits display light 28L into optical system 20 (e.g., images for view by the user's left eye). Device 10 may include a second (right) projector 18R that emits display light 28R (e.g., images for view by the user's right eye).

Optical system 20 may redirect display light 28L to left eye box 24L via three or more reflections within optical system 20. Optical system 20 may also redirect display light 28R to right eye box 24R via three or more reflections within optical system 20. Optical system 20 may also perform one or more refractions on display light 28L and display light 28R if desired. At the same time, optical system 20 may transmit outside light 26 to eye boxes 24L and 24R (e.g., for overlaying the outside light 26 with virtual images in display light 28L and 28R).

Projectors 18L and 18R may include respective emissive display panels and are therefore sometimes referred to herein as display panels 18L and 18R. Each display panel may include an array of pixels (e.g., emissive light sources that each emit a respective pixel of the image light). The pixels may be formed from light-emitting diodes, organic light-emitting diodes, or lasers, as examples. If desired, display panel 18L may be replaced with two adjacent emissive display panels (e.g., for emitting two respective channels of display light 28L) and/or display panel 18R may be replaced with two adjacent emissive display panels (e.g., for emitting two respective channels of display light 28R).

Optical system 20 of device 10 may have one or more adjustable tint layers for darkening ambient light to improve the viewability of display content on displays 60. Additionally, optical system 20 may include one or more adjustable haze layers for diffusing ambient light to further improve the viewability of display content on displays 60 by blurring objects in the background. If desired, the tint and haze layers in optical system 20 may be switchable so that device 10 can switch between a dark mode (e.g., in which display content on displays 60 is viewed while the haze and tint layers darken and diffuse ambient light) and a see-through or transparent mode (e.g., in which the haze and tint layers are clear and ambient light is not diffused or darkened). This allows viewers to easily switch between real-world interactions and immersive viewing experiences without removing device 10, if desired.

In some arrangements, optical system 20 may be configured to transmit display light from a target display in an external electronic device (e.g., a cellular telephone display, a tablet computer display, a laptop computer display, and/or any other external display). This may be especially beneficial in scenarios where the display content on device 10 is provided by or controlled using the external electronic device. In these types of arrangements, the user may need to interact with the external electronic device while wearing the head-mounted display. For example, the user may use the display on the external electronic device to select or adjust the display content that the user is viewing on displays 60. By using optical systems 20 in device 10 that are optimized for viewing the external display while darkening and diffusing ambient light, the user can view bright display content on both display 60 of device 10 as well as the display of an external electronic device, without the interference or distraction of ambient light.

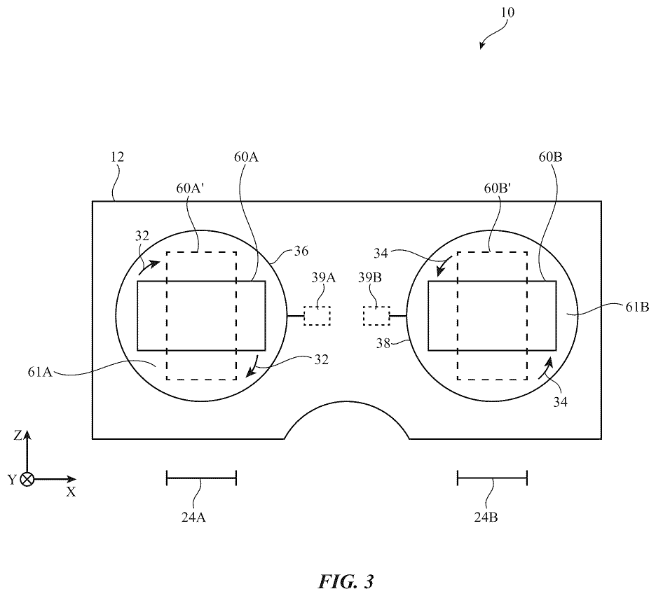

In some embodiments, it may be desirable to switch displays 60 between displaying landscape-oriented (e.g., horizontal) content and displaying portrait-oriented (e.g., vertical) content. To accommodate both horizontal content and vertical content, an entirety of displays 60 or a portion of displays 60 may be movable, such as rotatable, between different positions. An illustrative example of a head-mounted device having rotatable displays is shown in FIG. 3.

As shown in FIG. 3, device 10 may include displays 60A and 60B in housing 12. In the illustrative example of FIG. 3, housing 12 is a goggle-type head-mounted device housing. However, this is merely illustrative. In general, housing 12 may have any suitable form factor, such as glasses.

Displays 60A and 60B may be mounted in openings 36 and 38, respectively. Openings 36 and 38 may be formed in housing 12 and may be partial openings or through openings. In some embodiments, openings 36 and 38 may be filled with material 61A and 61B, respectively, that surrounds displays 60. Material 61A and material 61B may include fabric, elastomer, polymer, and/or other suitable material(s). In this way, openings 36 and 38 may allow displays 60 to rotate, and material 61 may hide openings 36 and 38 from view.

Displays 60A and 60B may display images that are viewable from eye boxes 24A and 24B, respectively. In particular, displays 60A and 60B may emit light (e.g., through one or more optical modules 20) that form images at eye boxes 24A and 24B.

The images displayed at eye boxes 24A and 24B may include horizontal and/or vertical content. For example, the images may include images and/or videos that are produced with a horizontal or vertical FOV. Alternatively, the images may include content that is viewed more comfortably on a horizontal or vertical display. For example, a document, social media timeline, webpage, or other content may be longer in a vertical direction that it is wide, making it more suitable for displaying on a vertical display.

To accommodate displaying images that are suitable for horizontal and vertical orientations, display 60A and/or display 60B may be adjustable. In the example of FIG. 3, for example, display 60A may be moved from an initial horizontal orientation (also referred to as a horizontal state herein) in direction 32 to position 60A′ in which display 60A is in a vertical orientation (also referred to as a vertical state herein). Similarly, display 60B may be moved from a horizontal orientation along direction 34 to position 60B′ in which display 60B is in a vertical orientation. In other words, displays 60 may be rotated in the XZ-plane of FIG. 3. In the horizontal orientation, displays 60 may operate in a horizontal field-of-view (FOV) mode, and in the vertical orientation, displays 60 may operate in a vertical FOV mode.

Displays 60A and 60B may be moved manually by a user (e.g., by physically rotating displays 60A and 60B about an axis/axle), may be moved automatically by optional motors 39A and 39B, respectively (e.g., stepper motors or other motors in housing 12), or may be moved in any other suitable manner. If displays 60A and 60B are moved automatically by a motor, a controller in device 10 (e.g., controller 14 of FIG. 1) may send a signal to the motor to move displays 60 based on the content to be displayed on displays 60. For example, controller 14 may move displays 60 from the horizontal orientation to the vertical orientation in response to a vertical image/content that is to be displayed on displays 60. Alternatively, if displays 60 are moved manually, the controller may signal to a user (e.g., through a message displayed on displays 60) to rotate displays 60, and/or a user of device 10 may rotate displays 60 without prompting by displays 60.

Although FIG. 3 shows displays 60A and 60B moving from an entirely horizontal orientation to an entirely vertical orientation (e.g., by rotating displays 60A and 60B) 90°, this is merely illustrative. In general, display 60A and/or display 60B may be rotated by any suitable angle(s) when it is desired to display vertical content (in the vertical FOV mode) and when it is desired to display horizontal content (in the horizontal FOV mode). For example, displays 60 may be rotated at least 45°, at least 60°, at least 80°, between 50° and 85°, or another suitable angle to switch between the horizontal FOV and vertical FOV modes. Alternatively or additionally, displays 60 may be rotatable between different angles, such as between different detents and/or other locking positions.

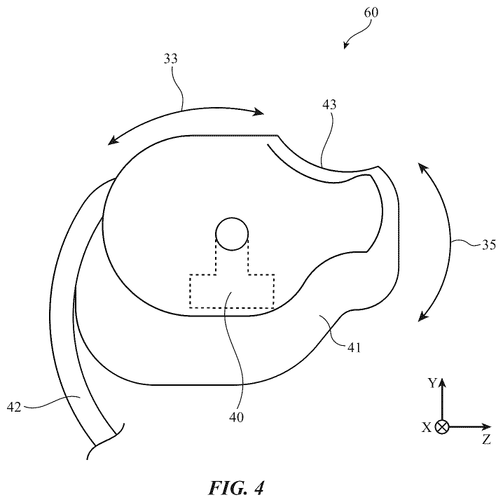

In the example of FIG. 4, displays 60 are shown as rotating in directions 32 and 34 in the XZ-plane. In other words, displays 60 may rotate in a single plane. However, this is merely illustrative. In some embodiments, displays 60 may be rotatable in multiple planes. An illustrative example is shown in FIG. 4.

As shown in FIG. 4, display 60 may be coupled to mount 40. Mount 40 may include a ball and socket joint or another suitable joint to allow display 60 to rotate in directions 33 (e.g., directions 32/34 of FIG. 3) in the XZ-plane, as well as in directions 35 in the YZ-plane (orthogonal to directions 33. For example, display 60 may be rotatable at least 45°, at least 60°, at least 80°, between 50° and 85°, or other suitable amount in directions 33, and may be rotatable at least 1°, at least 2°, at least 5°, between 1° and 10°, less than 20°, or other suitable amount in directions 35.

In some embodiments, by allowing display 60 to rotate in directions 35 in addition to directions 33, display 60 may be rotated to prevent display 60 from applying force on the user's nose and/or brow when display 60 is being rotated. For example, a sensor in electronic device 10, such as a camera or other optical sensor of sensors 16 (FIG. 1), may scan the user's face, and display 60 may be rotated (e.g., by a motor) based on the scan of the user's face. In particular, display 60 may be rotated to allow display 60 to be close to the user's eyes, while avoiding applying unnecessary pressure to the user's nose/brow. However, this is merely illustrative. Rotating display 60 in directions 35 may provide enhanced fit/comfort for a user or may be used to reposition display 60 relative to a user's eyes as desired.

In addition to, or instead of, allowing display 60 to rotate in directions 35, display 60 may have portions with sidewalls of varying curvature, such as sidewalls 41 and 43 of FIG. 4. As shown in FIG. 4, sidewalls 41 and 43 may be curved sidewalls with an opposite curvature (e.g., a concave curvature) from the curvature of the rest of the sidewalls (e.g., a convex curvature). However, this is merely illustrative. In some embodiments, sidewall 41 and/or sidewall 43 may be planar (e.g., not curved) or have less curvature from the rest of the sidewalls. By including sidewall portions with at least first and second different curvatures, a user's nose and/or brow may be accommodated as display 60 rotates.

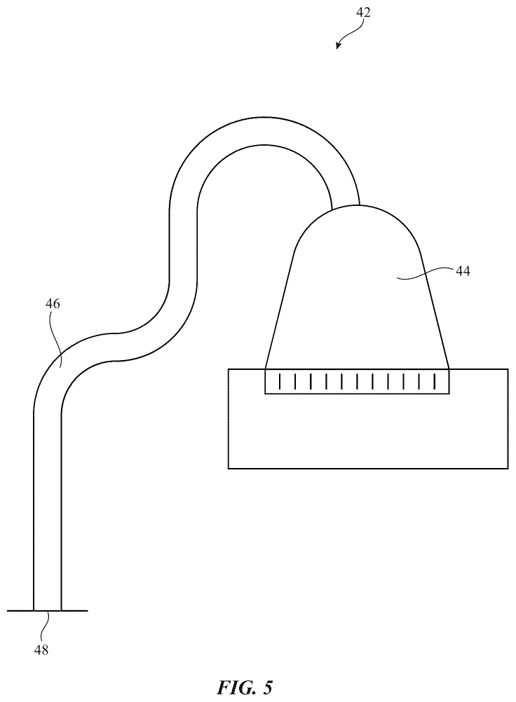

Display 60 may be coupled to circuitry in an electronic device, such as control circuitry 14 in electronic device 10 of FIG. 1, via flex service loop 42. For example, flex service loop 42 may couple display 60 to control circuitry 14, and data and/or power may be transmitted to display 60 over flex service loop 42. Flex service loop 42 may be flexible to allow display 60 to rotate in directions 33 and/or directions 35. An illustrative example of a flex service loop is shown in FIG. 5.

As shown in FIG. 5, flex service loop 42 may have flex 46 coupled to connector 44. Connector 44 may include a printed circuit board (PCB) or another suitable connector to couple to control circuitry in the electronic device. Flex 46 may be a flexible printed circuit or a flexible cable, and may carry power and/or data from connector 44 to end 48 of flex service loop 42. A display, such as display 60 (FIGS. 1-5) may be coupled to flex service loop 42 at end 48 and may receive the power and/or data from a power source (e.g., a power source in circuitry 16 of FIG. 1) and/or the control circuitry.

Flex 46 of flex service loop 42 may include flexible materials, such as elastomer, rubber, thin metal, and/or other suitable material to allow flex 46 to move as a display to which flex 46 is connected is rotated. In this way, the display may receive power and/or data and may rotate to switch between horizontal and vertical fields of view.

Although FIGS. 4 and 5 have shown flex service loop 42 coupling display 60 to control circuitry, this is merely illustrative. In some embodiments, display 60 may be a solid-state display and have on-board power and data components. As a result, when display 60 rotates, the on-board power and data components may rotate with display 60. In general, any suitable component(s) may be formed on-board display 60, and display 60 may be coupled to any suitable component(s) via flex service loop 42.

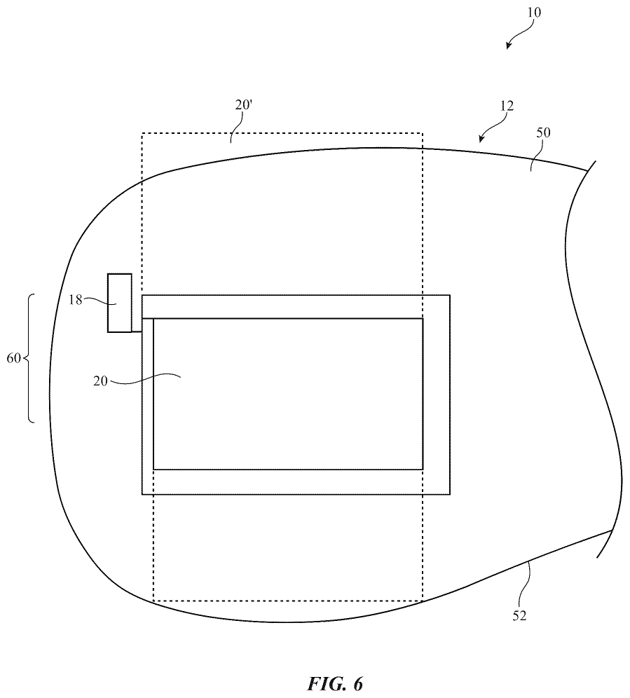

Although HMD displays have been described as rotating to switch between horizontal FOV and vertical FOV modes, this is merely illustrative. In general, HMD displays may be moved or adjusted in any suitable manner to switch between horizontal FOV and vertical FOV modes. For example, in some embodiments, HMD displays may be expanded to switch from a horizontal FOV mode to a vertical FOV mode. An illustrative example is shown in FIG. 6.

As shown in FIG. 6, device 10 may include display 60 in housing 12. In the illustrative example of FIG. 6, housing 12 is a glasses (e.g., eyeglasses) device housing (e.g., having frame 50, nose bridge 52, and temples (not shown in FIG. 6 for clarity) extending from frame 50). Frame 50 and nose bridge 52 may be formed from plastic, metal, polymer, and/or other suitable material(s). However, this is merely illustrative. In general, housing 12 may have any suitable form factor, such as goggles.

Display 60 may include projector 18 and optical module 20. For example, projector 18 may be mounted in a side portion of frame 50 (e.g., near one of the temples) and may emit light into optical module 20. Optical module 20 may include a waveguide that guides light from projector 18 to an eye box of device 10 for viewing by a user of device 10. In particular, the waveguide may include one or more input couplers that couple the light emitted by projector 18 into the waveguide and one or more output couples that couple the light out of the waveguide to the eye box.

Optical system 20 may initially be in a horizontal FOV mode in a first state. When it is desired to switch display 60 into a vertical FOV mode, optical system 20 may be expanded to position 20′ (a second state). For example, optical system 20 (e.g., the waveguide of optical system 20) may be extended, unfolded, slid, or otherwise expanded from its initial position to position 20′. In this way, display 60 may be switched between the horizontal FOV mode to the vertical FOV mode. When it is desired to switch back to the horizontal FOV mode, optical system 20 may be retracted, folded, slid, or otherwise moved from position 20′ to its initial position.

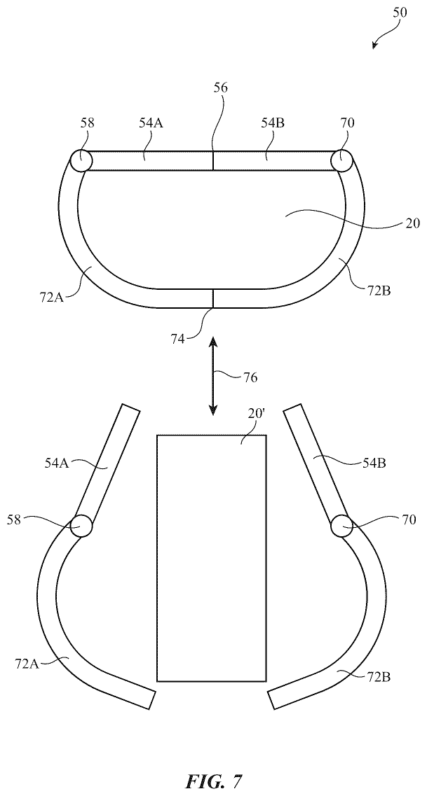

To accommodate display 60 in both the horizontal FOV mode and the vertical FOV mode, frame 50 may have movable portions. An illustrative example is shown in FIG. 7.

As shown in FIG. 7, frame 50 may include upper portions 54A and 54B and lower portions 74A and 74B. Optical module 20 may be mounted between upper portions 54 and lower portions 72.

Upper portion 54A and lower portion 72A may be coupled to hinge 58. Similarly, upper portion 54B and lower portion 72B may be coupled to hinge 70. Upper portion 54A and upper portion 54B may meet at seam 56, and lower portion 72A and lower portion 72B may meet at seam 74.

Initially, optical system 20 may be oriented for an associated display to be in a horizontal FOV mode. When it is desired to switch the display to a vertical FOV mode, optical system 20 may be expanded, and the portions of frame 50 may be moved to accommodate the expansion of optical system 20. For example, as shown in FIG. 7, upper portion 54A may rotate away from upper portion 54B about hinge 58, while upper portion 54B may rotate away from upper portion 54A about hinge 70. Similarly, lower portion 72A may rotate away from lower portion 72B about hinge 58, while lower portion 72B may rotate away from lower portion 72A about hinge 70. Upper portions 54 and lower portions 72 may be moved manually by a user of the electronic device, may be moved automatically in response to the expansion of optical module 20, and/or may be moved by one or more motors coupled to frame 50 (e.g., stepper motors or other suitable motors). In this way, optical system 20 in position 20′ may be accommodated by frame 50.

Frame 50 may be adjusted between the horizontal FOV and vertical FOV states by switching between the two modes as illustrated by arrows 76. In this way, frame 50 may have a traditional glasses shape when the display is in the horizontal FOV mode, while frame 50 may expand to accommodate the vertical FOV mode.

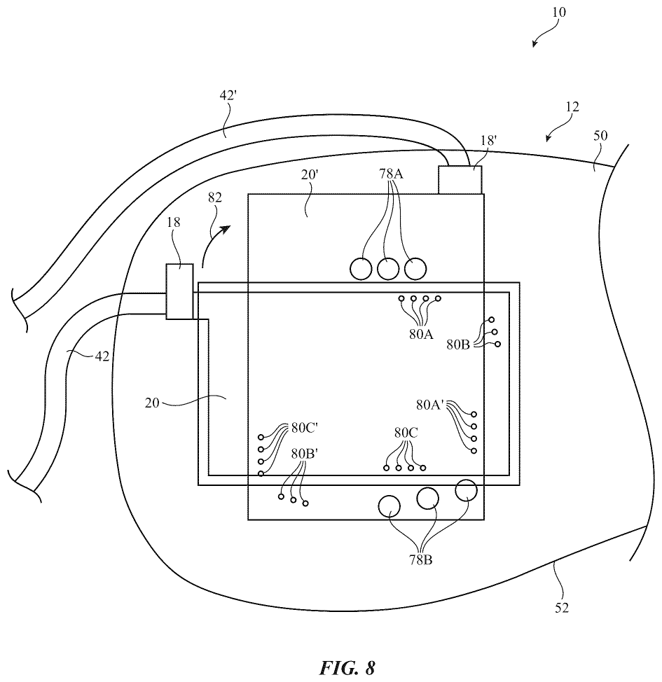

In the examples of FIGS. 6 and 7, optical system 20 has been described as being expandable to switch between the horizontal FOV mode and the vertical FOV mode. However, this is merely illustrative. In some embodiments, optical system 20 may be repositioned by a user relative to frame 50 to switch between the horizontal FOV mode and the vertical FOV mode. An illustrative example is shown in FIG. 8.

As shown in FIG. 8, optical module 20 may be coupled directly to projector 18 (e.g., projector 18 may be attached to and/or integrated with optical module 20), and optical module 20 may be coupled to frame 50 with magnets 78A and/or 78B. In other words, optical module 20 may have magnets that mate with magnets on frame 50 to hold optical module 20 in place. Projector 18 may be coupled to flex service loop 42, if desired. However, projector 18 may be a solid-state projector with on-board components, and flex service loop 42 may be omitted in some embodiments. In the example of FIG. 8, optical module 20 may include a thin-film waveguide (e.g., a waveguide formed from thin-film dielectric layers) formed on a lens. However, this is merely illustrative. In general, optical module 20 may include one or more suitable waveguides and/or lenses.

Optical module 20 may initially be in a horizontal FOV mode in a first state. To switch optical module 20 into a vertical FOV mode, optical module 20 may be detached from frame 50 (e.g., pulled away from frame 50 with enough force to overcome the magnetic attraction force of magnets 78A and 78B), rotated in direction 82, and reattached to frame 50 (e.g., attached to magnets 78A and/or magnets 78B) in position 20′ (a second state). To return to the horizontal FOV mode, optical module 20 may be returned to its initial position. In this way, optical module 20 may be rotated to switch a display between the horizontal FOV mode and the vertical FOV mode.

If desired, optical module 20 may include additional light emitters 80A, 80B, and/or 80C. Light emitters 80A, 80B, and 80C may be supplemental, low-resolution light sources, such as light-emitting diodes (LEDs) around a periphery of optical module 20. Light emitters 80A, 80B, and/or 80C may emit diffuse (low-resolution) light instead of, or in addition to, the light emitted by projector 18 when optical module 20 is in the horizontal FOV mode, and/or may emit the diffuse (low-resolution) light instead of, or in addition to, the light emitted by projector 18 when optical module 20 is in the vertical FOV mode in position 20′ (e.g., when light emitters 80A, 80B, and 80C are in positions 80A′, 80B′, and 80C′). In this way, light emitters 80 may supplement or replace the light emitted by projector 18.

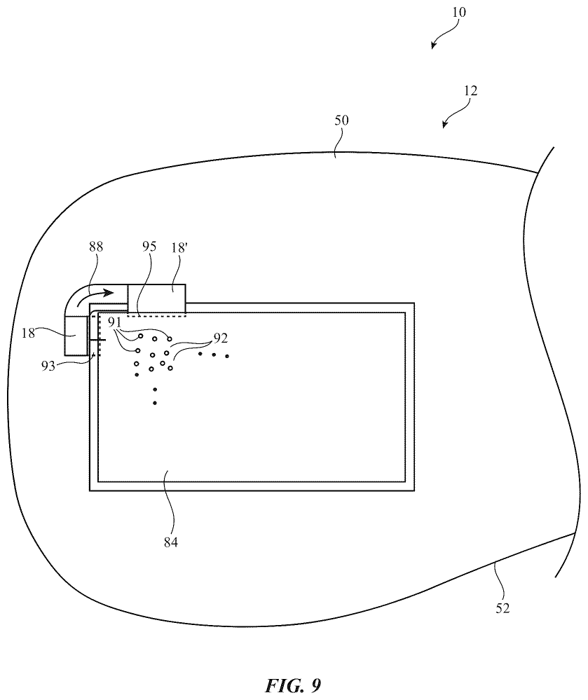

In some embodiments, an HMD display may be switched between a horizontal FOV mode and a vertical FOV mode by moving a projector while leaving an associated optical module/waveguide in place. In particular, the waveguide may be bi-directional and emit light in the horizontal FOV mode or the vertical FOV mode based on the placement of the projector. An illustrative example is shown in FIG. 9.

As shown in FIG. 9, bi-directional waveguide 84 (which may be a portion of an optical module) may be mounted in frame 50, and projector 18 may be mounted in frame 50 and oriented to emit light into bi-directional waveguide 84. Bi-directional waveguide 84 may include two extraction patterns, shown in FIG. 9 as illustrative horizontal extraction array 91 and vertical extraction array 92. In particular, horizontal extraction array 91 may include extraction elements (such as bumps, ridges, prisms, etc.) that extract light out of waveguide 84 when it is emitted from projector 18 in its initial position, and vertical extraction array 92 may include extraction elements (such as bumps, ridges, prisms, etc.) that extract light out of waveguide 84 when it is emitted from projector 18 in position 18′.

Horizontal extraction array 91 and vertical extraction array 92 may correspond with different pathways (e.g., light inputted from projector 18 at position 18′ may only be routed through vertical extraction array 92, and light inputted from projector 18 at the initial position may only be routed through horizontal extraction array 91). Alternatively or additionally, projector 18 may be overlapped by optional polarizer 93 at the initial position, and projector 18 may be overlapped by optional polarizer 95 at position 18′. Polarizers 93 and 95 may be linear polarizers, circular polarizers, or other suitable polarizers that polarize the light emitted by projector 18 differently (e.g., p-polarization vs. s-polarization or other suitable polarization difference). Horizontal extraction array 91 may include filters that select for light that has passed through polarizer 93, while vertical extraction array 92 may include filters that select for light that has passed through polarizer 95. In this way, projector 18 and bi-directional waveguide 84 may form a display that is operated in a horizontal FOV mode when projector 18 is in its initial position in a first state.

When it is desirable to operate the display in a vertical FOV mode, projector 18 may be moved in direction 88 to position 18′ (a second state) at the top of bi-directional waveguide 84. In this way, projector 18 and bi-directional waveguide 84 may form a display that operates in the vertical FOV mode when projector 18 is in position 18′. Projector 18 may be moved back and forth between its initial position and position 18′ to switch between the horizontal FOV mode and the vertical FOV mode.

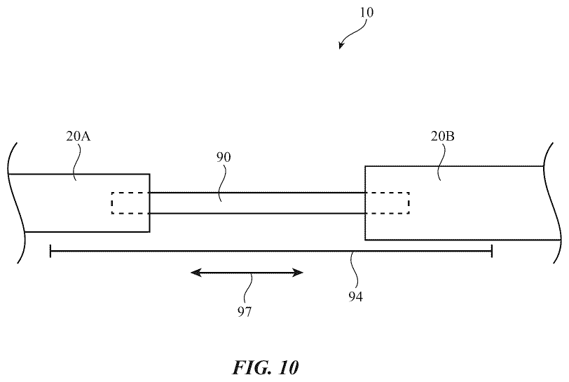

In some embodiments, when an optical module/waveguide is moved to switch an HMD display from a horizonal FOV mode to a vertical FOV mode (e.g., as in FIGS. 3, 4, and 6-8), the positions of the optical modules may change. As a result, the optical centers of the optical modules may not align with the user's eyes. Therefore, it may be desirable to allow the optical modules to move laterally relative to one another so that they can be repositioned relative to the user's eyes. An illustrative example of a coupling mechanism that allows the optical modules to move laterally relative to one another is shown in FIG. 10.

As shown in FIG. 10, device 10 may include optical modules 20A and 20B. Optical modules 20A and 20B may be coupled to one another using connector 90. Connector 90 may be, for example, an elastomer, polymer, or other material that is friction fit with (or otherwise adjustably connected to) optical modules 20A and 20B.

Optical modules 20A and 20B may have center-to-center spacing 94. In some embodiments, it may be desirable for center-to-center spacing 94 to be equivalent to a user's interpupillary distance (IPD). In other words, the user's pupils may be aligned with the centers of optical modules 20.

After optical modules 20A and 20B are rotated, expanded/retracted, slid, or otherwise moved to change optical modules 20 between a horizontal FOV mode to a vertical FOV mode, center-to-center spacing 94 may no longer correspond with the user's IPD. Therefore, optical modules 20A and 20B may be moved in directions 97 (e.g., toward one another or away from one another) to adjust center-to-center spacing 94. In other words, optical modules 20 may be slid along connector 90, and center-to-center spacing 94 may be adjusted to match the user's IPD.

Optical modules 20A and 20B may be moved in directions 97 to adjust center-to-center spacing 94 manually (e.g., a user may slide optical modules 20 along connector 90) and/or automatically (e.g., one or more motors, such as stepper motors, may move optical modules 20A and 20B along connector 90, such as in response to a measurement of center-to-center spacing 94 and a comparison to the user's IPD). In this way, optical modules 20 may be moved to match center-to-center spacing 94 to the user's IPD.

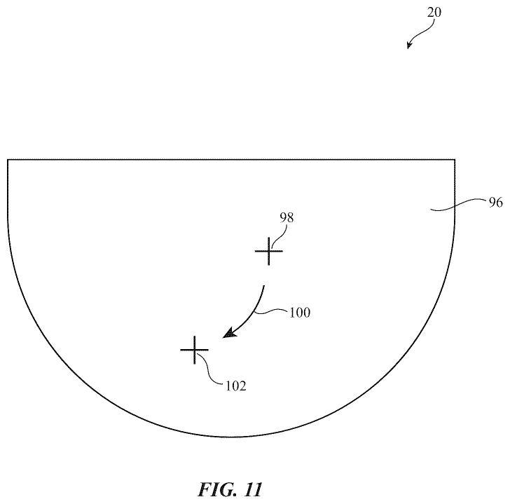

In addition to, or instead of, adjusting the center-to-center spacing between optical modules 20, optical modules 20 may be modified to ensure that the centers of optical modules 20 remain aligned with the centers of the user's eyes when optical modules 20 are rotated. An illustrative example is shown in FIG. 11.

As shown in FIG. 11, optical module 20 may include lens 96 with center 98 as defined by a modulation transfer function (MTF). Therefore, center 98 may be referred to as MTF center 98 herein. MTF center 98 may be aligned with the center of the user's eye when optical module 20 is in the horizontal FOV mode. However, when optical module 20 is rotated, the user's eye may become aligned with point 102 as indicated by rotational direction 100.

To correct for this issue, optical module 20 (or an entirety of a display if an entire display is rotated) may be rotated about MTF center 98. In other words, optical module 20 may be coupled to a rotator, such as mount 40 of FIG. 4, at MTF center 98. In this way, when the rotator rotates optical module 20, MTF center 98 may remain aligned with the center of the user's eye.

Alternatively or additionally, lens 96 of optical module 20 may have multiple MTF centers in different locations. For example, lens 96 may have multiple concavities and/or convexities to have multiple focus points. In the illustrative example of FIG. 11, lens 96 may have MTF center 98 and an additional MTF center at point 102. Therefore, the center of the user's eye may be aligned with MTF center 98 when optical module 20 is in the horizontal FOV mode and may be aligned with the additional MTF center at point 102 when optical module 20 is in the vertical FOV mode. In this way, the center of the user's eye may remain aligned with an MTF center of lens 96 regardless of the operating mode of optical module 20.

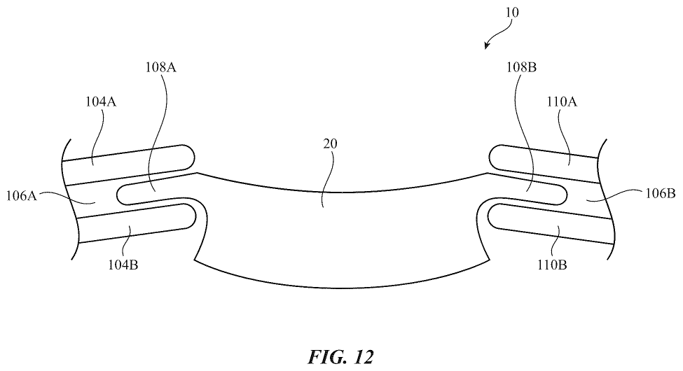

In some embodiments, to accommodate rotation and/or other movement of optical module 20, optical module 20 may be mounted in a channel. An illustrative example is shown in FIG. 12.

As shown in FIG. 12, optical module 20 may have flange 108 (with illustrative portions 108A and 108B) mounted to housing portions 104 and 110. Housing portions 104 and 110 may be, for example, a portion of a goggle-type housing (e.g., as shown in FIG. 3), a glasses-type housing (e.g., a frame as shown in FIG. 6), or any other suitable housing. Housing portions 104 and 110 may be formed from elastomer, polymer, metal, and/or any other suitable material(s).

Housing portions 104A and 104B may form channel portion in which flange portion 108A rests, and housing portions 110A and 110B may form channel portion 106B. Channel portions 106A and 106B may together form a channel (e.g., an undercut channel) in which flange portion 108B rests. Housing portions 104 and 110 may apply pressure to flange 108, for example, to maintain the rotational position of optical module 20 in the absence of force applied by a user or a motor in device 10.

When it is desired to rotate optical module 20, a user or a motor may apply a rotational force to optical module 20 clockwise or counterclockwise into or out of the page in the arrangement of FIG. 12. As optical module 20 rotates, flange 108 may also rotate about channel 106. In this way, optical module 20 may be adjusted between the horizontal FOV mode and the vertical FOV mode, and housing portions 104 and 110 may maintain the position of optical module 20 in electronic device 10.

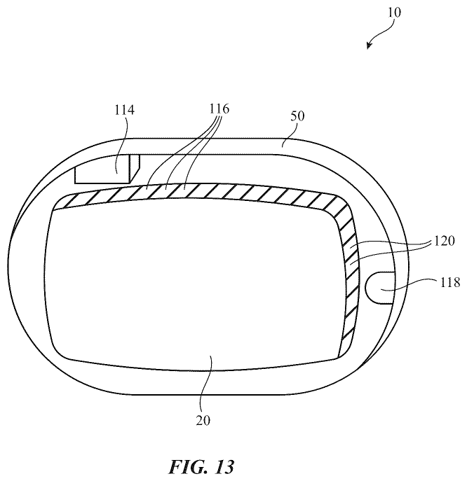

In some embodiments, device 10 may include an encoder to determine the position of optical module 20 and/or detents to provide feedback to a user making adjustments to the position of optical module 20. An illustrative example is shown in FIG. 13.

As shown in FIG. 13, encoder 114 may be coupled to a portion of housing 12. Encoder 114 may be, for example, a magnetic encoder, an optical encoder, a capacitive encoder, or another suitable encoder. Optical module 20 may include corresponding encoder components 116, which may be magnets, optical patterns, electronic components, and/or other suitable encoder components. In general, encoder components 116 may match the type of encoder used for encoder 114.

In operation, as optical module 20 rotates or otherwise moves, encoder 114 may determine the position of optical module 20 using encoder 114. In response to the determined position of optical module 20, control circuitry, such as control circuitry 14 of FIG. 1, may adjust the display, such as changing the displayed content, rescaling the displayed content, and/or reorienting the displayed content. For example, the orientation of the content (landscape vs. portrait orientation) may be adjusted based on whether it is determined that optical module 20 is in the horizontal FOV mode or the vertical FOV mode. In some illustrative embodiments, the content may be displayed in a landscape orientation when optical module 20 is in the horizontal FOV mode and may be displayed in a portrait orientation when optical module 20 is in the vertical FOV mode. However, this is merely illustrative. In general, the content may be displayed with any suitable orientation based on the measured position of optical module 20, and encoder 114 may determine any suitable position of optical module 20, such as one or more positions between the horizontal FOV mode and the vertical FOV mode.

Although FIG. 13 shows determining the position of optical module 20 using encoder 114, this is merely illustrative. In some embodiments, optical module 20 may include an inertial measurement unit (IMU), accelerometer, gyroscope, and/or other position/motion sensors, and the position of optical module 20 may be determined using the one or more position/motion sensors.

Although FIG. 13 shows determining the position of optical module 20, this is merely illustrative. In some embodiments, if an entire display (e.g., display 60 of FIG. 3) moves/rotates, an encoder or other position/motion sensor may be used to determine the position of the display.

Instead of, or in addition to, including encoder 114, detents may be formed in device 10 to control the potential positions of optical module 20 and/or to provide feedback to a user moving optical module 20. In the example of FIG. 13, frame 50 may include one or more features 118, and optical module 20 may include matching features 120. For example, features 118 may be protrusions (e.g., teeth, bumps, ridges, etc.) or recesses, and matching features 120 may be matching recesses or protrusions. In this way, as optical module 20 is rotated, features 118 may engage with matching features 120, and optical module 20 may be maintained in set positions and/or the user adjusting optical module 20 may be provided with feedback and optical module 20 is moved.

Although feedback is shown in FIG. 13 as being based on detents, this is merely illustrative. Optical module 20 may instead by mounted in housing 12 with a friction bearing, a hinge (e.g., a friction-based hinge), and/or other mechanisms to provide feedback as optical module 20 is rotated or otherwise moved.

Although FIG. 13 shows including detents between optical module 20 and frame 50, this is merely illustrative. In some embodiments, if an entire display (e.g., display 60 of FIG. 3) moves/rotates, detents may be incorporated between the display and the surrounding head-mounted device housing.

As described above, one aspect of the present technology is the gathering and use of information such as information from input-output devices. The present disclosure contemplates that in some instances, data may be gathered that includes personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, username, password, biometric information, or any other identifying or personal information.

The present disclosure recognizes that the use of such personal information, in the present technology, can be used to the benefit of users. For example, the personal information data can be used to deliver targeted content that is of greater interest to the user. Accordingly, use of such personal information data enables users to have control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the United States, collection of or access to certain health data may be governed by federal and/or state laws, such as the Health Insurance Portability and Accountability Act (HIPAA), whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to provide certain types of user data. In yet another example, users can select to limit the length of time user-specific data is maintained. In addition to providing “opt in” and “opt out” options, the present disclosure contemplates providing notifications relating to the access or use of personal information. For instance, a user may be notified upon downloading an application (“app”) that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of information that may include personal information data to implement one or more various disclosed embodiments, the present disclosure also contemplates that the various embodiments can also be implemented without the need for accessing personal information data. That is, the various embodiments of the present technology are not rendered inoperable due to the lack of all or a portion of such personal information data.

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Computer-generated reality: in contrast, a computer-generated reality (CGR) environment refers to a wholly or partially simulated environment that people sense and/or interact with via an electronic system. In CGR, a subset of a person's physical motions, or representations thereof, are tracked, and, in response, one or more characteristics of one or more virtual objects simulated in the CGR environment are adjusted in a manner that comports with at least one law of physics. For example, a CGR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a CGR environment may be made in response to representations of physical motions (e.g., vocal commands). A person may sense and/or interact with a CGR object using any one of their senses, including sight, sound, touch, taste, and smell. For example, a person may sense and/or interact with audio objects that create 3D or spatial audio environment that provides the perception of point audio sources in 3D space. In another example, audio objects may enable audio transparency, which selectively incorporates ambient sounds from the physical environment with or without computer-generated audio. In some CGR environments, a person may sense and/or interact only with audio objects. Examples of CGR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationery with respect to the physical ground. Examples of mixed realities include augmented reality and augmented virtuality. Augmented reality: an augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof. Augmented virtuality: an augmented virtuality (AV) environment refers to a simulated environment in which a virtual or computer generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

Hardware: there are many different types of electronic systems that enable a person to sense and/or interact with various CGR environments. Examples include head mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mounted system may have one or more speaker(s) and an integrated opaque display. Alternatively, a head mounted system may be configured to accept an external opaque display (e.g., a smartphone). The head mounted system may incorporate one or more imaging sensors to capture images or video of the physical environment, and/or one or more microphones to capture audio of the physical environment. Rather than an opaque display, a head mounted system may have a transparent or translucent display. The transparent or translucent display may have a medium through which light representative of images is directed to a person's eyes. The display may utilize digital light projection, OLEDs, LEDs, μLEDs, liquid crystal on silicon, laser scanning light sources, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

The foregoing is merely illustrative and various modifications can be made to the described embodiments. The foregoing embodiments may be implemented individually or in any combination.

What is claimed is:

1. A head-mounted device, comprising
a housing; and
a display in the housing, wherein the display is configured to move between a first state in which the display is in a horizontal field-of-view mode and a second state in which the display is in a vertical field-of-view mode.

2. The head-mounted device of claim 1, wherein the display is configured to rotate between the first state and the second state.

3. The head-mounted device of claim 2, further comprising:
an encoder coupled to the housing, wherein the encoder is configured to determine a position of the display, and the display is configured to be adjusted in response to the position.

4. The head-mounted device of claim 2, further comprising:
detents between the display and the housing, wherein the detents comprise matching features on the housing and on the display.

5. The head-mounted device of claim 2, further comprising:
a motor in the housing and coupled to the display, wherein the motor is configured to rotate the display between the first state and the second state.

6. The head-mounted device of claim 5, wherein the motor is configured to rotate the display in response to content on the display.

7. The head-mounted device of claim 2, further comprising:
a mount that couples the display to the housing, wherein the display is configured to rotate between the first state and the second state in a first plane and is further configured to rotate in a second plane that is different from the first plane.

8. The head-mounted device of claim 2, wherein the display comprises a sidewall with first and second different curvatures.

9. The head-mounted device of claim 2, further comprising:
control circuitry in the housing; and
a flex service loop that couples the display to the control circuitry.

10. The head-mounted device of claim 2, wherein the display comprises an optical module including a lens, the lens has a modulation transfer function (MTF) center, and the display is configured to rotate about the MTF center.

11. The head-mounted device of claim 2, wherein the display comprises an optical module including a lens, and the lens has a first modulation transfer function (MTF) center in a first location and a second MTF center in a second location that is different from the first location.

12. The head-mounted device of claim 2, wherein the housing comprises first and second housing portions that form a channel, the display comprises an optical module with a flange that protrudes into the channel to couple the optical module to the housing, and the flange is configured to rotate around the channel as the display rotates.

13. The head-mounted device of claim 1, wherein the display comprises an optical module that is configured to expand between the first state and the second state.

14. The head-mounted device of claim 13, wherein the housing comprises a frame with first and second portions respectively coupled to first and second hinges, and the first and second portions are configured to expand when the optical module expands between the first state and the second state.

15. The head-mounted device of claim 1, wherein the display comprises a projector and an optical module attached to the projector, the projector is configured to emit light into the optical module to form images, and the display is configured to magnetically attach to the housing in a first position in the first state and is configured to magnetically attach to the housing in a second position that is different from the first position in the second state.

16. The head-mounted device of claim 15, wherein the optical module comprises a periphery and supplemental light sources around the periphery.

17. The head-mounted device of claim 1, wherein the display comprises a projector and a waveguide, the projector is configured to rotate between the first and second states from a first position relative to the waveguide to a second position relative to the waveguide that is different from the first position, and the waveguide comprises a first array of horizontal extraction features that are configured to output light from the projector when the projector is in the first state and a second array of vertical extraction features that are configured to output the light from the projector when the projector is in the second state.

18. A head-mounted device, comprising:
a housing comprising first and second openings;
a first display coupled to the housing in the first opening; and
a second display coupled to the housing in the second opening, wherein the first and second displays are configured to rotate between a horizontal field-of-view mode and a vertical field-of-view mode.

19. The head-mounted device of claim 18, wherein the first display comprises a first optical module, the second display comprises a second optical module, the first and second optical modules are configured to move between a first state when the first and second displays are in the horizontal field-of-view mode and a second state when the first and second displays are in the vertical field-of-view mode, and the head-mounted device further comprises:
a connector that couples the first optical module to the second optical module, wherein the first and second optical modules are configured to be moved along the connector to adjust a center-to-center spacing of the first and second optical modules.

20. A head-mounted device, comprising:
a housing comprising first and second openings;
a first display coupled to the housing in the first opening;
a second display coupled to the housing in the second opening, wherein the first and second displays are configured to rotate between a first state in which the first and second displays are in a horizontal field-of-view mode and a second state in which the first and second displays are in a vertical field-of-view mode;
a power source in the housing;
a first flex service loop that couples the first display to the power source; and
a second flex service loop that couples the second display to the power source.
